(19) United States
(12) Patent Application Publication
(10) Pub. No.: US 2007/0072614 A1
(43) Pub. Date: Mar. 29, 2007

(54) Handover control in radio communication system

(75) Inventor: Dan Forsberg, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/514,164

(22) Filed: Sep. 1, 2006

(30) Foreign Application Priority Data
Sep. 27, 2005 (FI) 20055512

(51) Int. Cl. H04Q 7/20

(52) U.S. Cl. 455/436; 370/331

(57) ABSTRACT

A handover control method and a radio communication system comprising a mobile station and one or more base stations are provided. The mobile station receives transmissions from one or more base stations, and measures the signal strength of each received base station transmission. The base stations determine radio resource management related information regarding the base station and send the determined information to a mobile station. The mobile station combines information received from each base station with the measured signal strength of each base station, and sends the combined information to a base station. The base station receiving the information controls handover decisions regarding the mobile station on the basis of the received information.

### FIELD

The invention relates to handover control in a radio communication system.

### BACKGROUND

In many radio communication systems radio resource management is performed in a centralized manner. Radio resource management is responsible for controlling for example channel allocation and handovers in radio systems. In centralized radio resource management, the infrastructure of a radio system is interconnected in such a manner that radio resource related information may be communicated between different entities of the infrastructure. The infrastructure may comprise base stations and base station controllers, for example. Mobile stations of a system may perform measurements, transmit the measurements to base stations or base station controllers, which may perform radio resource management based on the measurements of the mobile stations and the base stations. For example, handover decisions are generally based on signal strength measurements. Handovers may be either infrastructure or mobile station initiated.

In systems with distributed radio resource management, centrally controlled management of radio resources does not exist. Typically, each base station is responsible for its own resources. It may be difficult to obtain a reliable handover decision in a system where base stations are not interconnected. In current Wireless Local Area Networks (WLAN 802.11) utilising decentralized control the mobile terminal makes the handover decision.

### BRIEF DESCRIPTION OF THE INVENTION

An object of the invention is to provide a solution for performing reliable handovers in systems without centralized radio resource management. According to an aspect of the invention, there is provided a handover control method in a radio communication system, the method comprising: measuring at the mobile station the signal strength of transmissions received from one or more base stations, determining at one or more base stations radio resource management related information regarding the base station, one or more base stations sending the determined information to a mobile station, the mobile station combining information received from each base station with the measured signal strength of each base station, and the mobile station sending the combined information to a base station, the base station receiving the information then controlling handover decisions regarding the mobile station on the basis of the received information.

According to another aspect of the invention, there is provided a radio communication system, comprising a mobile station and one or more base stations wherein the mobile station is configured to receive transmissions from one or more base stations and to measure the signal strength of each received base station transmission, the base stations are configured to determine radio resource management related information regarding the base station. The base stations are further configured to send the determined information to a mobile station, the mobile station is further configured to combine information received from each base station with the measured signal strength of each base station, and to send the combined information to a base station, and the base station receiving the information is configured to control handover decisions regarding the mobile station on the basis of the received information.

According to another aspect of the invention, there is provided a handover control method in a radio communication system, the method comprising: measuring at the mobile station the signal strength of transmissions received from one or more base stations, receiving in the mobile station radio resource management related information from one or more base stations, combining the information received from the base stations with the measured signal strength of each base station, and sending the combined information to a base station for handover controlling purposes.

According to another aspect of the invention, there is provided a mobile station of a radio communication system, wherein the mobile station is configured to receive transmissions from one or more base stations and to measure the signal strength of each received base station transmission. The mobile station comprises: a receiver for receiving radio resource management related information from one or more base stations, a controller for combining the information received from the base stations with the measured signal strength of each base station, and a transmitter for sending the combined information to a base station for handover controlling purposes.

According to another aspect of the invention, there is provided a base station of a radio communication system, wherein the base station is configured to be in connection with at least one mobile station and to determine radio resource management related information regarding the base station. The base station comprises a controller and a transmitter for sending the determined information to a mobile station, a receiver for receiving information from a mobile station, the information comprising radio resource management related information and signal strength information regarding a plurality of base stations, and a controller for controlling handover decisions regarding the mobile station on the basis of the received information.

The invention provides several advantages. The invention provides a solution for performing reliable handovers in systems where centralized radio resource management does not exist, for example in systems those where base stations are not interconnected. The proposed solution improves the scalability of the systems and makes the system architecture simple.

In an embodiment, the invention is applied to environments where multiple different radio technologies are utilised and vertical handovers are possible. A vertical handover means a handover where a mobile station switches from one radio technology to another. The proposed solution may be applied in an environment where mobile stations can simultaneously use multiple different radio technologies.

In an embodiment, the information determined by the base stations and transmitted to a mobile station need not be understood or decoded by the mobile station. The information may be in a form that only a base station can decode. Thus, the mobile station does not need to be aware of the coding used by the base stations. The coding may change in time, if needed, and the mobile stations need no updating because of the change.

### LIST OF DRAWINGS

In the following, the invention will be described in greater detail with reference to the embodiments and the accompanying drawings, in which

FIGS. 1A and 1B illustrate examples of radio communication systems;

FIG. 2 is a flowchart illustrating an embodiment of the invention;

FIG. 3 illustrates an example of a mobile station; and

FIG. 4 illustrates an example of a base station.

### DESCRIPTION OF EMBODIMENTS

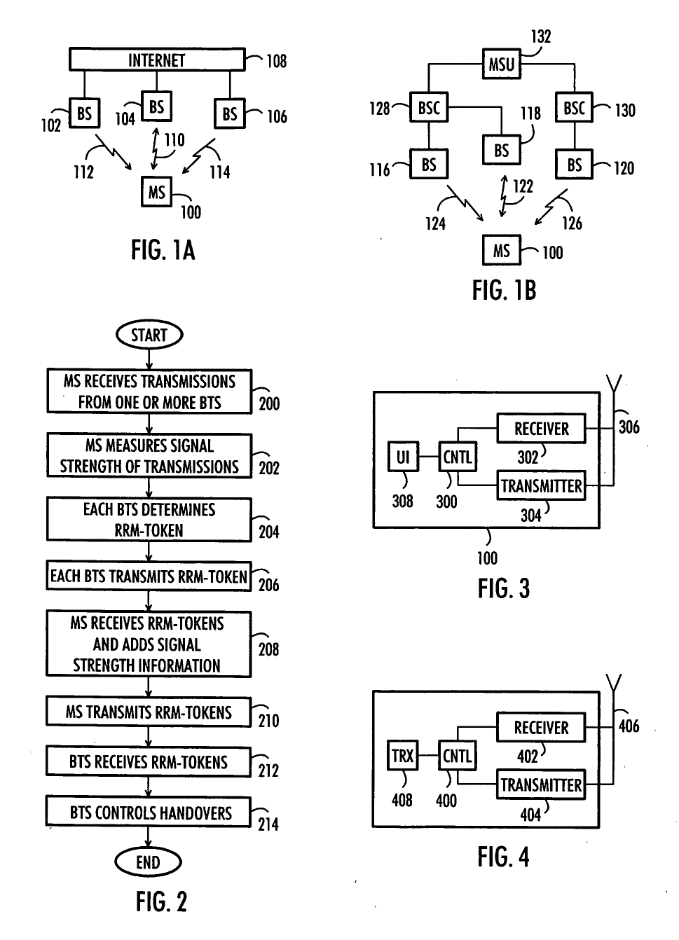

FIGS. 1A and 1B illustrate examples of radio communication systems in which embodiments of the invention can be applied. FIG. 1A shows a mobile station 100 and three base stations 102, 104, 106. In this example the mobile station is in bidirectional communication 110 with the base station 104. The communication may comprise a traffic channel and a control channel, for example. In addition, the mobile station receives transmissions 112, 114 from base stations 102 and 106. The transmissions 112, 114 may be broadcast control channels, for example. The channels may be circuit switched or packet switched channels and implemented with any multiple access method. The physical realisation of the channels is not relevant in this context.

The base stations 102, 104, 106 may be connected to the Internet 108, for example. The base stations may also be connected to a public telephone system (PSTN). The base stations are not directly interconnected and do not have a centralised radio resource control. The base stations may utilise different radio access technologies. Examples of radio access technologies are TDMA, FDMA, CDMA, WCDMA and different combinations of these.

FIG. 1B illustrates another example of a radio communication system. FIG. 1B shows a mobile station 100 and three base stations 116, 118, 120. In this example the mobile station is in bidirectional communication 122 with the base station 118. In addition, the mobile station receives transmissions 124,126 from the base stations 116 and 120.

The base stations 116 and 118 are connected to a base station controller 128 and the base station 120 is connected to a base station controller 130. Base station controllers 128, 130 are connected to a mobile switching centre 132, which is connected to other networks. In this example the base stations are connected to each other via a base station controller or a mobile switching centre. However, centralised radio resource control is not applied.

FIG. 2 is a flowchart illustrating an embodiment of the invention. In step 200, the mobile station 100 receives the transmissions of one or more base stations 102, 104, 106. The transmissions may be broadcast channel transmissions or traffic channel transmissions, as in the example of FIG. 1A.

In step 202, the mobile station measures the signal strength of each received base station transmission.

In step 204, each base station determines radio resource management related information regarding the base station. The radio resource management related information may comprise information about the identity, the type and capabilities of the base station, the number of mobile stations connected to the base station, the status or state of the base station, and information about the resources available in the base station. Through the capabilities, some of possible services can be determined. Examples of base station types are “stationary” (a normal stationary base station), “mobile” (a moving base station), “helping” (a temporary base station added to an area to meet the high peak demand for example in concerts etc.), “wireless” (the backbone network connection is wireless), and “wired” (the backbone network connection is wired). The resources may include the available radio channels or available transmission capacity of the base station. The state of the BS may be, for example, “full”, “half full”, “empty”, describing the capability of the base station to serve more mobile stations. The state may comprise values “gold service full”, “silver service empty”, “bronze service half full”, for example to denote different states for different QoS/charging service levels. The information may further comprise data about the available memory, the processing power, the uplink and downlink bandwidth of the base station. The information may further comprise information about the values of dynamic configuration parameters of the base station. The values of dynamic configuration parameters of the base station may comprise at least one of the following: “Going down for service break”, “High priority”, and “Low priority”, for example. The radio resource management related information may further comprise information about the interference level of available channels. The determined information may be called an RRM-Token (Radio Resource Management Token). The RRM-Token may comprise a plurality of fields, each field denoting a given type of information described above.

In step 206, the base stations 102, 104, 106 send the determined information to the mobile station 100. In an embodiment, the base stations transmit the information using a broadcast channel that may be received by any mobile station in the coverage area of the base station.

In an embodiment, the base stations may send the determined information on request. A mobile station may request each base station to send the RRM-Token if the measured strength of the transmission of the base station to which the mobile station is connected drops below a given threshold, for example.

In an embodiment, the base stations may send the determined information at regular intervals. The interval may be adjustable. The interval may be adjusted by an administrator, or it may change depending on the time, date or the load on the network, for example.

The RRM-Token transmission may be efficiently coded using a secure coding mechanism. In an embodiment, the base station codes the RRM-Token as bit fields, where each bit denotes a specific service availability (1: yes, 0: no). Bit vectors may also be used to denote the number of resources available (001=20%, 010=40%, 011=60%, 100=80%; 101=100%, for example). In addition, bit vectors may denote priority (0=low, 1=high. or 00=low, 01=medium, 10=high, 11=very high, for example).

In an embodiment, some of the parameters may be associated with a service id and a respective configuration. For each service, a number may be reserved and a possible value range. In coding, the result is value pairs, which are coded with numbers. For example for environment description, service number id may be number 1 and the possible value range may vary from 1 to 4, where 1 means indoors, 2 outdoors walking, 3 in a bus, 4 in a subway.

In step 208, the mobile station 100 receives the information transmitted by the base stations 102, 104 and 106. The mobile station combines information received from each base station with the measured signal strength of each base station. In an embodiment, the mobile station is not aware of the contents of the received RRM-Tokens. The mobile station can merely identify which base stations sent which token. The information in the RRM-token may be in a form that only a base station can decode. Thus, the mobile station does not need to be aware of the coding used by the base stations. The coding may change in time, if needed, and the mobile stations need no updating because of the change.

In step 210, the mobile station sends the combined information to a base station. In an embodiment, the base station is the base station with which the mobile station has an uplink connection. In the example of FIG. 1A, the information is sent to the base station 104.

In an embodiment, the RRM-Tokens of base stations received with very low signal strength may be omitted from the transmission. In an embodiment, the mobile station compares the signal strength of each received base station transmission to a predetermined threshold and sends the combined information of those base stations which were received with a signal strength greater than the predetermined threshold. The threshold may be a configurable parameter configured by the operator of the network, the device manufacturer, or by another network element through a configuration interface. The threshold may also be manually configured. The threshold may be set dynamically by means of an algorithm or different input parameters (such as the number of base stations detected and the signal strengths of the base stations, for example.

In step 212, the base station 104 receives the information. The information comprises the RMM-Tokens of the base stations the mobile station is receiving and the signal strengths with which the mobile station receives the transmission of the base stations.

In step 214, the base station 104 decodes the information and controls handover decisions regarding the mobile station on the basis of the decoded information. Based on the received information, the base station 104 can make an efficient decision on where to command the mobile station to perform a handover, if one is needed.

For example, if the mobile station is receiving the transmission of the base station 102 with a considerably better signal strength compared to the signal strength of the transmission of the base station 104, and the base station 102 reports in the RRM-Token that it has available capacity, the base station 104 may command the mobile station to make a handover to base station 102.

In an embodiment, the fields of the RRM-Token may have a default value. Each field is included in the transmission of the RRM-Token only if the value deviates from the default value. Thus, transmission capacity may be saved.

In an embodiment, the mobile station adds contextual information to the report to be sent to the current BTS along with the BS RMM tokens. The contextual information may be called an MS token. In this embodiment, the current BTS may also receive more information about the mobile station's environment and is therefore able to better predict the movements of the mobile station and the resources needed.

The contextual information may comprise information about at least one of the following: location coordinates of the mobile station, velocity and direction of movement of the mobile station, environment description and mobility description. The location may be determined using a satellite location system such as a GPS (Global Positioning System), for example. Also other location determination solutions may be applied. The mobility description of the mobile station may comprise information on how the mobile station is moving (walking, car, bus, subway), for example. The environment description of the mobile station may be a shopping mall, open street, city center, conurbation, or other value describing the environment.

The contextual information may further comprise information about preferred properties of the connection between the mobile station and a base station. The preferred properties may be taken into account in radio resource management. Examples of the preferred properties include “prefer cheapest connections”, “prefer highest bandwidth”, “prefer best service quality” and “prefer this service provider”.

The contextual information may further comprise information about the capabilities of the mobile station. The capabilities may include: “supported radios: WLAN, Bluetooth, WiMAX . . . ”, “support for simultaneous multiradio usage: yes/no”, for example.

With reference to FIG. 3, examine an example of a mobile station 100 in which embodiments of the invention can be applied. The mobile station comprises a controller 300, typically implemented with a microprocessor, a signal processor or separate components and associated software. The mobile station further comprises a receiver 302, a transmitter 304 and an antenna 306 with which the mobile station 100 is able to communicate with base stations. The mobile station may further comprise a user interface 308. The user interface may comprise a display 102, a keyboard, a speaker and a microphone, for example. Depending on the type of the mobile station, various number of user interface parts may be used. The mobile station may be a mobile phone, a computer, a laptop computer, a personal digital assistant (PDA) or any other similar device.

The controller 300, the receiver 302 and the transmitter 304 may be configured to perform at least some of the steps described in connection with the flowchart of FIG. 2.

With reference to FIG. 4, examine an example of a base station 104 in which embodiments of the invention can be applied. The base station comprises controller 400, typically implemented with a microprocessor, a signal processor or separate components and associated software. The base station further comprises a receiver 402, a transmitter 404 and an antenna 406 with which the base station 104 is able to communicate with mobile stations. The base station may further comprise a transceiver 408 with which the base station may be connected to other networks, such as the Internet, or to a base station controller. The base station may have a wireless or a wireline connection with a network, base station controller or other base stations.

The controller 400, the receiver 402 and the transmitter 404 may be configured to perform at least some of the steps described in connection with the flowchart of FIG. 2.

The embodiments may be implemented as a computer program comprising instructions for executing a computer process for controlling handover in a radio communication system, the process comprising: measuring the signal strength of transmissions received from one or more base stations, receiving radio resource management related information from one or more base stations, combining information received from the base stations with the measured signal strength of each base station, and sending the combined information to a base station for handover controlling purposes.

The computer program may be stored on a computer program distribution medium readable by a computer or a processor. The computer program medium may be, for example but not limited to, an electric, magnetic, optical, infrared or semiconductor system, device or transmission medium. At least one of the following media may be included: a computer readable medium, a program storage medium, a record medium, a computer readable memory, a random access memory, an erasable programmable read-only memory, a computer readable software distribution package, a computer readable signal, a computer readable telecommunications signal, computer readable printed matter, and a computer readable compressed software package.

Even though the invention has been described above with reference to an example according to the accompanying drawings, it is clear that the invention is not restricted thereto but it can be modified in several ways within the scope of the appended claims.

1. A handover control method in a radio communication system, the method comprising:
measuring, at a mobile station, signal strength of transmissions received from one or more base stations;
determining, at the one or more base stations, radio resource management related information regarding the base station,
sending by the one or more base stations, the information to the mobile station;
combining, at the mobile station, the information received from each base station with the signal strength of each base station;
sending, by the mobile station, the information as combined information to a base station;
receiving, at the base station, the information; and
controlling handover decisions regarding the mobile station based on the received information.

2. The method of claim 1, wherein determining the radio resource management related information comprises determining the radio resource management related information comprising information about at least one of the following:
identity of the base station,
type of the base station,
capabilities of the base station,
a number of mobile stations connected to the base station,
status of the base station,
information about resources of the base station, and
information about values of dynamic configuration parameters of the base station.

3. The method of claim 2, wherein determining the information about the resources of the base station comprises determining information about at least one of the following:
available memory, processing power, uplink bandwidth of the base station, and downlink bandwidth of the base station.

4. The method of claim 2, wherein determining the radio resource management related information comprises determining the values of the dynamic configuration parameters of the base station comprising at least one of the following: going down for service break, high priority, and low priority.

5. The method of claim 1, further comprising:
adding, at the mobile station, contextual information to the information received from each base station before sending the information further, the contextual information relating to at least one of the following:
location coordinates of the mobile station,
velocity and direction of movement of the mobile station,
environment description, and
mobility description.

6. The method of claim 5, wherein adding the contextual information comprises adding contextual information comprising information about preferred properties of a connection between the mobile station and the base station.

7. The method of claim 5, wherein adding the contextual information comprises adding contextual information comprising information about capabilities of the mobile station.

8. The method of claim 1, further comprising:
sending, by the mobile station, the combined information to a connected base station with which the mobile station has an uplink connection.

9. The method of claim 1, wherein sending comprises sending by a radio technology of a plurality of radio technologies that the base stations can use.

10. The method of claim 1, further comprising:
comparing, by the mobile station, the signal strength of each received base station transmission to a predetermined threshold, and
sending, by the mobile station, combined information of those base stations that were received with signal strength greater than the predetermined threshold.

11. A radio communication system, comprising:
a mobile station; and
one or more base stations, wherein the mobile station is configured to receive transmissions from one or more base stations and measure a signal strength of each received base station transmission,
wherein the base stations are configured to determine the base stations' own radio resource management related information and to send the information to the mobile station,
wherein the mobile station is further configured to combine information received from each base station with a measured signal strength of each base station, and to send combined information to a handover base station, and
wherein the handover base station receiving the combined information is configured to control handover decisions regarding the mobile station based on the combined information.

12. A handover control method in a radio communication system, the method comprising:
measuring, at a mobile station, signal strength of transmissions received from one or more base stations,
receiving, in the mobile station, radio resource management related information from the one or more base stations,
combining the information received from the one or more base stations with the signal strength of each base station, and
sending the information, after combining, to a handover base station for handover controlling purposes.

13. The method of claim 12, wherein the radio resource management related information comprises information about at least one of the following:
identity of base station,
base station type,
base station capabilities,
number of mobile stations connected to base station,
base station status,
information about values of dynamic configuration parameters of base station, and
information about resources of base station.

14. A mobile station of a radio communication system, wherein the mobile station is configured to receive transmissions from one or more base stations and to measure signal strength of each received base station transmission, the mobile station comprising:
a receiver for receiving radio resource management related information from one or more base stations,
a controller for combining the information received from the one or more base stations with the measured signal strength of each base station, and
a transmitter for sending the information, after combining, to a base station for handover controlling purposes.

15. A mobile station of claim 14, the controller being further configured to add contextual information to the information received from the one or more base stations before sending the information further, the contextual information relating to at least one of the following:
location coordinates of the mobile station,
velocity and direction of movement of the mobile station,
environment description, and
mobility description.

16. A mobile station of claim 14, the contextual information further relating to preferred properties of the connection between the mobile station and a base station.

17. A mobile station of claim 14, the contextual information further relating to the capabilities of the mobile station.

18. A base station of a radio communication system, wherein the base station is configured to be connected to at least one mobile station and to determine radio resource management related information regarding the base station, the base station comprising:
a first controller and a transmitter for sending the radio resource management related information to a mobile station,
a receiver for receiving combined information from a mobile station, the combined information comprising additional radio resource management related information and signal strength information regarding a plurality of base stations, and
a second controller for controlling handover decisions regarding the mobile station based on the received information.

19. A computer program product encoding a computer program of instructions for executing a computer process for controlling handover in a radio communication system, the process comprising:
measuring signal strength of transmissions received from one or more base stations,
receiving radio resource management related information from the one or more base stations,
combining into combined information the radio resource management related information received from the one or more base stations with the signal strength measured for each base station, and
sending the combined information to a handover base station for handover controlling purposes.

20. A computer program distribution medium readable by a computer and encoding a computer program of instructions for executing a computer process for controlling handover in a radio communication system, the process comprising:
measuring signal strength of transmissions received from the one or more base stations,
receiving radio resource management related information from the one or more base stations,
combining into combined information the radio resource management related information received from the base stations with the measured signal strength of each base station, and
sending the combined information to a handover base station for handover controlling purposes.

21. The computer program distribution medium of claim 20, the distribution medium including at least one of the following media:
a computer readable medium,
a program storage medium,
a record medium,
a computer readable memory,
a computer readable software distribution package,
a computer readable signal,
a computer readable telecommunications signal, and
a computer readable compressed software package.
